(19) United States
(12) Patent Application Publication
(10) Pub. No.: US 2025/0306540 A1
(43) Pub. Date: Oct. 2, 2025

(54) BUILDING MANAGEMENT SYSTEM WITH FDD-BASED AUTONOMOUS CONTROL

(71) Applicant: Tyco Fire & Security GmbH, Neuhausen am Rheinfall (CH)

(72) Inventors: Vineet Binodshanker Sinha, Brookfield, WI (US); Tushar Kshirsagar, Allentown, PA (US); Uday Chakrapani, Chembur (IN); Tulshiram Waghmare, Pimple Gurav (IN); Kerry Caravello, Mukwonago, WI (US); Sourabh Taranath Joshi, Wagholi (IN)

(21) Appl. No.: 18/821,435

(22) Filed: Aug. 30, 2024

(30) Foreign Application Priority Data
Mar. 29, 2024 (IN) 202441025874

(51) Int. Cl. G05B 11/01; G05B 23/02

(52) U.S. Cl. CPC G05B 11/01; G05B 23/0245; G05B 23/0294; G05B 2223/02

(57) ABSTRACT

The present disclosure relates to a BMS that includes processor(s) that execute instructions to obtain a fault rule related to a building parameter and determine that a fault has occurred based on the fault rule and initial BMS data indicating an initial value of the building parameter. The instructions cause the processors to perform an automatic fault correction process including increasing or decreasing an operational value of building equipment that operate to affect the building parameter by a preset interval, operating the building equipment using the increased or decreased operational value to affect the building parameter, and determining whether the fault was resolved. Responsive determining that the fault was not resolved, the instructions cause the processor(s) to repeat the automatic fault correction process until either the fault is resolved, or the operational value of the building equipment reaches a minimum or maximum value threshold.

### CROSS-REFERENCE TO RELATED PATENT APPLICATION

The present application claims the benefit of and priority to Indian Provisional Patent Application No. 202441025874, filed Mar. 29, 2024, the entire disclosure of which is incorporated by reference herein.

### BACKGROUND

The present disclosure relates generally to building management systems (BMS). The present disclosure relates more particularly to building management systems having autonomous control.

A Building Management System (BMS) or Building Automation System (BAS) is, in general, a system of devices configured to control, monitor, and/or manage equipment in or around a building or building area. A BMS or BAS can include, for example, a HVAC system, a security system, a lighting system, a fire alerting system, any other system that is capable of managing building functions or devices, or any combination thereof. The terms BMS and BAS are used synonymously throughout the present disclosure.

A BAS may be controllable from a localized and/or an onsite premise. For example, a BAS may be controllable by an admin within a building. The admin may control the BAS using a computing device (e.g., a desktop computer).

It would be desirable to automate control of the BAS according to a set of user defined rules.

### SUMMARY

One embodiment of the present disclosure relates to a building management system (BMS) that includes one or more memory devices storing instructions thereon that, when executed by one or more processors, cause the one or more processors to perform operations including obtaining a fault rule related to one or more building parameters. The operations further include determining that a fault has occurred based on the fault rule and initial BMS data indicating an initial value of the building parameter. Responsive to determining that the fault has occurred, the operations include performing an automatic fault correction process including increasing or decreasing an operational value of building equipment that operate to affect the building parameter by a preset interval, operating the building equipment using the increased or decreased operational value to affect the building parameter, and determining whether the fault was resolved after operating the building equipment using the increased or decreased operational value based on new BMS data indicating a new value of the building parameter. Responsive to determining that the fault was not resolved, the operations include repeating the automatic fault correction process until either the fault is resolved, or the operational value of the building equipment reaches a minimum or maximum value threshold.

In some embodiments, the operations include providing a user interface to a user device, the user interface comprising a plurality of selectable elements and receive, via the user device displaying the user interface, an indication of a selection of a first selectable element of the plurality of selectable elements. The first selectable element can be associated with a rule editor for a building parameter of the one or more building parameters. The operations further include causing the one or more processors to identify, responsive to the receipt of the indication, an updated rule for the building parameter.

In some embodiments, the operations include obtaining a rule for a building parameter of the one or more building parameters, the building parameter including the minimum or maximum value threshold for the operational value and the preset interval for increasing or decreasing the operational value.

In some embodiments the operations include providing a user interface to a user device. The user interface includes a graphical representation of a rule for a building parameter of the one or more building parameters, and an audit log containing elements representative of the fault and a successful resolution of the fault.

In some embodiments the user interface is updated to include a potential savings value resulting from performing the automatic fault correction process for all detected faults, and an actual savings value resulting from current settings that do not perform the automatic fault correction process for all faults.

In some embodiments the fault rule for the one or more building parameters identifies a first BMS point that provides values of the building parameter. The first BMS point is monitored to determine whether the fault has occurred. The rule for the building parameter further identifies a second BMS point that provides values of the operational value of the building equipment, wherein the second BMS point is adjusted to affect the operation of the building equipment.

In some embodiments the fault rule includes an indication as to whether the fault rule is set to advisory mode or automatic mode, and the automatic fault correction process is performed responsive to determining that the fault has occurred and the fault rule is set to automatic mode. A recommendation is provided responsive to determining that the fault has occurred and the fault rule is set to advisory mode.

In some embodiments, the operations include transmitting a failure message to the user device indicating that the automatic fault correction process failed to correct the fault responsive to determining that the operational value of the building equipment has reached the minimum or maximum value threshold and the fault has not been resolved.

In some embodiments the minimum or maximum value threshold is defined as a percentage. The operations include applying the percentage to a default value of the operational value to determine a numerical threshold, and comparing a current value of the operational value to determine whether the minimum or maximum value threshold has been reached.

In some embodiments, the preset interval is defined as a percentage. The operations include applying the percentage to a default value of the operational value to determine an amount by which the operational value is increased or decreased when adjusting by the preset interval.

Another embodiment relates to a method that includes obtaining a fault rule related to one or more building parameters. The method further includes determining that a fault has occurred based on the fault rule and initial BMS data indicating an initial value of the one or more building parameters. Responsive to determining that the fault has occurred, the method further includes performing an automatic fault correction process including increasing or decreasing an operational value of building equipment that operate to affect the one or more building parameters by a preset interval, operating the building equipment using the increased or decreased operational value to affect the one or more building parameters, and determining whether the fault was resolved after operating the building equipment using the increased or decreased operational value based on new BMS data indicating a new value of the one or more building parameters. The method further includes repeating the automatic fault correction process, responsive to determining that the fault was not resolved, until either the fault is resolved or the operational value of the building equipment reaches a minimum or maximum value threshold.

In some embodiments, the method includes providing a user interface to a user device. The user interface can include a plurality of selectable elements. The method further includes receiving, via the user device displaying the user interface, an indication of a selection of a first selectable element of the plurality of selectable elements, the first selectable element being associated with a rule editor for a building parameter of the one or more building parameterrs, and identifying, responsive to the receipt of the indication, an updated rule for the building parameter.

In some embodiments, the method includes receiving a rule for a building parameter of the one or more building parameters, the rule for the building parameter comprising the minimum or maximum value threshold for the operational value and the preset interval for increasing or decreasing the operational value.

In some embodiments, the method includes providing a user interface to a user device. The user interface can include a graphical representation of a rule for a building parameter of the one or more building parameters, and an audit log containing elements representative of the building parameter and a successful update of the building parameter.

In some embodiments, the method includes calculating a potential savings value resulting from performing the automatic fault correction process for all detected faults. The method further includes calculating an actual savings value resulting from current settings that do not perform the automatic fault correction process for all faults and updating the user interface to display the calculated potential savings value and actual savings value.

In some embodiments, the fault rule further includes an indication as to whether the fault rule is set to advisory mode or automatic mode, and the automatic fault correction process is performed responsive to determining that the fault has occurred and the fault rule is set to automatic mode, a recommendation is provided responsive to determining that the fault has occurred and the fault rule is set to advisory mode.

In some embodiments, the method further includes transmitting a failure message to the user device indicating that the automatic fault correction process failed to correct the fault responsive to determining that the operational value of the building equipment has reached the minimum or maximum value threshold and the fault has not been resolved.

Another embodiment relates to a user device storing instructions thereon that, when executed by one or more processors, cause the one or more processors to perform operations including: receiving a rule for a building parameter, transmitting, to a BMS, the rule for the building parameter and receiving, from the BMS, equipment data for a plurality of pieces of building equipment. The equipment data can include updates to the building parameter. The operations further include, generating, using the equipment data for the plurality of pieces of building equipment and the updates to the building parameter, a plurality of recommendations to adjust operational parameters for the plurality of pieces of building equipment, and providing, responsive to generating the plurality of recommendations, a user interface to the user device.

The user interface can include a graphical representation to indicate the plurality of recommendations, and an element to indicate the updates to the building parameter.

In some embodiments the operations include receiving, from the BMS, a savings value resulting from implementing one or more of the plurality of recommendations and updating the user interface to display the savings value.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a building management system (BMS), according to some embodiments.

FIG. 2 is a block diagram of a BMS that serves the building of FIG. 1, according to some embodiments.

FIG. 3 is a block diagram of a BMS controller which can be used in the BMS of FIG. 2, according to some embodiments.

FIG. 4 is another block diagram of the BMS that serves the building of FIG. 1, according to some embodiments.

FIG. 5 is another block diagram of the BMS that serves the building of FIG. 1, according to some embodiments.

FIG. 6A is a flowchart of a process for resolving, or recommending adjustments to, resolve faults, according to some embodiments.

FIG. 6B is a continuation of the flowchart of the process shown in FIG. 6A for resolving, or recommending adjustments to, resolve faults, according to some embodiments.

FIG. 7 is a rule editor that can be used to define a custom diagnostic rule is shown, according to some embodiments.

FIG. 8 is an asset manager GUI that can be accessed by a user on a user device is shown, according to some embodiments.

FIG. 9 is the asset manager of FIG. 8 in another view, according to some embodiments.

FIG. 10 is the asset manager of FIG. 8 in another view, according to some embodiments.

FIG. 11 is the asset manager of FIG. 8 is shown in another view, according to some embodiments.

FIG. 12 is an equipment view portion of the asset manager of FIG. 8, according to some embodiments.

FIG. 13 is another equipment view portion of the asset manager of FIG. 8, according to some embodiments.

### DETAILED DESCRIPTION

### Overview

Referring generally to the FIGURES, a building management system (BMS) with automated fault detection and diagnostics systems is shown, according to exemplary embodiments. A BMS is, in general, a system of devices configured to control, monitor, and manage equipment in or around a building or building area. A BMS can include a heating, ventilation, or air conditioning (HVAC) system, a security system, a lighting system, a fire alerting system, another system that is capable of managing building functions or devices, or any combination thereof. BMS devices may be installed in any environment (e.g., an indoor area or an outdoor area) and the environment may include any number of buildings, spaces, zones, rooms, or areas. A BMS may include VERASYS® building controllers or other devices sold by Johnson Controls, Inc., as well as building devices and components from other sources.

A Building Automation System (BAS) is, in general, a system of devices configured to control, monitor, and/or manage equipment in or around a building or building area. A BAS can include, for example, a HVAC system, a security system, a lighting system, a fire alerting system, any other system that is capable of managing building functions or devices, or any combination thereof.

In a brief overview, the BMS described herein provides a customizable rules editor that facilitates automated operation of various building equipment according to the rules set by default, or in the rules editor. The BMS includes a controller with a processing circuit, a communications interface, and memory storing fault rules, parameter limits, and interval limits. The processor executes changes to operational values and building parameters stored in memory to operate building equipment based on the stored rules. As used herein, operational values means any of, or any combination of: setpoints, operational commands (e.g., open/close damper, modulate value, operating actuators, etc.), system configurations, low level control parameters, and/or any other BMS points or control signals which can be used to control the operation of equipment, either directly or indirectly.

Users can create custom fault rules or diagnostic rules using conditional logic and set parameter ranges to limit changes made by the BMS. The BMS detects faults based on the preset rules. The BMS may operate in “action mode” (i.e., automatic mode) or in advisory mode. In automatic mode, the BMS adjusts building parameters within preset limits to resolve faults. The BMS maintains an audit log of adjustments made, successes, failures, and recommended changes. Users can access a rule editor and an asset manager interface to view the audit log, define rules, set parameter ranges, view recommended adjustments, and monitor equipment performance.

### Building and Building Management System

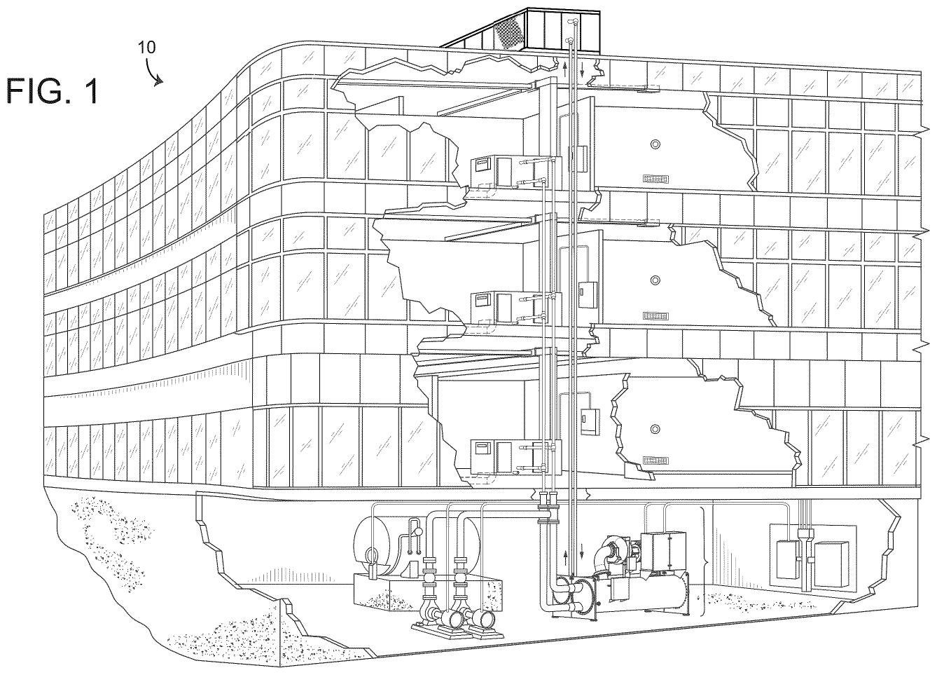

Referring now to FIG. 1, a perspective view of a building 10 is shown, according to an exemplary embodiment. A BMS serves building 10. The BMS for building 10 may include any number or type of devices that serve building 10. For example, each floor may include one or more security devices, video surveillance cameras, fire detectors, smoke detectors, lighting systems, HVAC systems, or other building systems or devices. In modern BMSs, BMS devices can exist on different networks within the building (e.g., one or more wireless networks, one or more wired networks, etc.) and yet serve the same building space or control loop. For example, BMS devices may be connected to different communications networks or field controllers even if the devices serve the same area (e.g., floor, conference room, building zone, tenant area, etc.) or purpose (e.g., security, ventilation, cooling, heating, etc.).

BMS devices may collectively or individually be referred to as building equipment. Building equipment may include any number or type of BMS devices within or around building 10. For example, building equipment may include controllers, chillers, rooftop units, fire and security systems, elevator systems, thermostats, lighting, serviceable equipment (e.g., vending machines), and/or any other type of equipment that can be used to control, automate, or otherwise contribute to an environment, state, or condition of building 10. The terms “BMS devices,” “BMS device” and “building equipment” are used interchangeably throughout this disclosure.

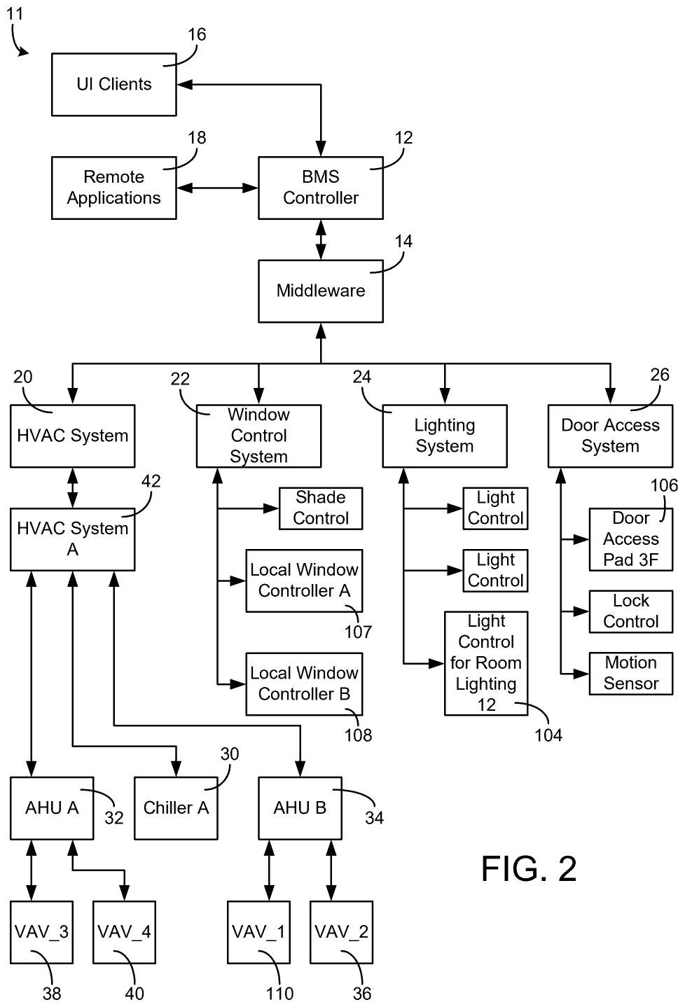

Referring now to FIG. 2, a block diagram of a BMS 11 for building 10 is shown, according to an exemplary embodiment. BMS 11 is shown to include a plurality of BMS subsystems 20-26. Each BMS subsystem 20-26 is connected to a plurality of BMS devices and makes data points for varying connected devices available to upstream BMS controller 12. Additionally, BMS subsystems 20-26 may encompass other lower-level subsystems. For example, an HVAC system may be broken down further as “HVAC system A,” “HVAC system B,” etc. In some buildings, multiple HVAC systems or subsystems may exist in parallel and may not be a part of the same HVAC system 20.

As shown in FIG. 2, BMS 11 may include a HVAC system 20. HVAC system 20 may control HVAC operations building 10. HVAC system 20 is shown to include a lower-level HVAC system 42 (named “HVAC system A”). HVAC system 42 may control HVAC operations for a specific floor or zone of building 10. HVAC system 42 may be connected to air handling units (AHUs) 32, 34 (named “AHU A” and “AHU B,” respectively, in BMS 11). AHU 32 may serve variable air volume (VAV) boxes 38, 40 (named “VAV_3” and “VAV_4” in BMS 11). Likewise, AHU 34 may serve VAV boxes 36 and 110 (named “VAV_2” and “VAV_1”). HVAC system 42 may also include chiller 30 (named “Chiller A” in BMS 11). Chiller 30 may provide chilled fluid to AHU 32 and/or to AHU 34. HVAC system 42 may receive data (i.e., BMS inputs such as temperature sensor readings, damper positions, temperature setpoints, etc.) from AHUs 32, 34. HVAC system 42 may provide such BMS inputs to HVAC system 20 and on to middleware 14 and BMS controller 12. Similarly, other BMS subsystems may receive inputs from other building devices or objects and provide the received inputs to BMS controller 12 (e.g., via middleware 14).

Middleware 14 may include services that allow interoperable communication to, from, or between disparate BMS subsystems 20-26 of BMS 11 (e.g., HVAC systems from different manufacturers, HVAC systems that communicate according to different protocols, security/fire systems, IT resources, door access systems, etc.). Middleware 14 may be, for example, an EnNet server sold by Johnson Controls, Inc. While middleware 14 is shown as separate from BMS controller 12, middleware 14 and BMS controller 12 may integrated in some embodiments. For example, middleware 14 may be a part of BMS controller 12.

Still referring to FIG. 2, window control system 22 may receive shade control information from one or more shade controls, ambient light level information from one or more light sensors, and/or other BMS inputs (e.g., sensor information, setpoint information, current state information, etc.) from downstream devices. Window control system 22 may include window controllers 107, 108 (e.g., named “local window controller A” and “local window controller B,” respectively, in BMS 11). Window controllers 107, 108 control the operation of subsets of window control system 22. For example, window controller 108 may control window blind or shade operations for a given room, floor, or building in the BMS.

Lighting system 24 may receive lighting related information from a plurality of downstream light controls (e.g., from room lighting 104). Door access system 26 may receive lock control, motion, state, or other door related information from a plurality of downstream door controls. Door access system 26 is shown to include door access pad 106 (named “Door Access Pad 3F”), which may grant or deny access to a building space (e.g., a floor, a conference room, an office, etc.) based on whether valid user credentials are scanned or entered (e.g., via a keypad, via a badge-scanning pad, etc.).

BMS subsystems 20-26 may be connected to BMS controller 12 via middleware 14 and may be configured to provide BMS controller 12 with BMS inputs from various BMS subsystems 20-26 and their varying downstream devices. BMS controller 12 may be configured to make differences in building subsystems transparent at the human-machine interface or client interface level (e.g., for connected or hosted user interface (UI) clients 16, remote applications 18, etc.). BMS controller 12 may be configured to describe or model different building devices and building subsystems using common or unified objects (e.g., software objects stored in memory) to help provide the transparency. Software equipment objects may allow developers to write applications capable of monitoring and/or controlling various types of building equipment regardless of equipment-specific variations (e.g., equipment model, equipment manufacturer, equipment version, etc.). Software building objects may allow developers to write applications capable of monitoring and/or controlling building zones on a zone-by-zone level regardless of the building subsystem makeup.

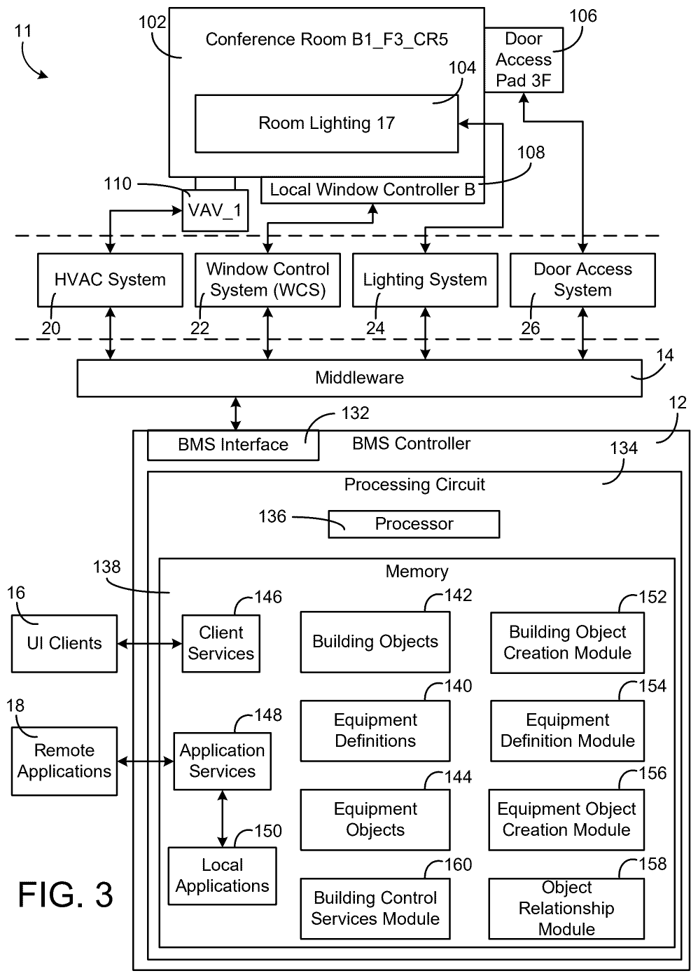

Referring now to FIG. 3, a block diagram illustrating a portion of BMS 11 in greater detail is shown, according to an exemplary embodiment. Particularly, FIG. 3 illustrates a portion of BMS 11 that services a conference room 102 of building 10 (named “B1_F3_CR5”). Conference room 102 may be affected by many different building devices connected to many different BMS subsystems. For example, conference room 102 includes or is otherwise affected by VAV box 110, window controller 108 (e.g., a blind controller), a system of lights 104 (named “Room Lighting 17”), and a door access pad 106.

Each of the building devices shown at the top of FIG. 3 may include local control circuitry configured to provide signals to their supervisory controllers or more generally to the BMS subsystems 20-26. The local control circuitry of the building devices shown at the top of FIG. 3 may also be configured to receive and respond to control signals, commands, setpoints, or other data from their supervisory controllers. For example, the local control circuitry of VAV box 110 may include circuitry that affects an actuator in response to control signals received from a field controller that is a part of HVAC system 20. Window controller 108 may include circuitry that affects windows or blinds in response to control signals received from a field controller that is part of window control system (WCS) 22. Room lighting 104 may include circuitry that affects the lighting in response to control signals received from a field controller that is part of lighting system 24. Access pad 106 may include circuitry that affects door access (e.g., locking or unlocking the door) in response to control signals received from a field controller that is part of door access system 26.

Still referring to FIG. 3, BMS controller 12 is shown to include a BMS interface 132 in communication with middleware 14. In some embodiments, BMS interface 132 is a communications interface. For example, BMS interface 132 may include wired or wireless interfaces (e.g., jacks, antennas, transmitters, receivers, transceivers, wire terminals, etc.) for conducting data communications with various systems, devices, or networks. BMS interface 132 can include an Ethernet card and port for sending and receiving data via an Ethernet-based communications network. In another example, BMS interface 132 includes a Wi-Fi transceiver for communicating via a wireless communications network. BMS interface 132 may be configured to communicate via local area networks or wide area networks (e.g., the Internet, a building WAN, etc.).

In some embodiments, BMS interface 132 and/or middleware 14 includes an application gateway configured to receive input from applications running on client devices. For example, BMS interface 132 and/or middleware 14 may include one or more wireless transceivers (e.g., a Wi-Fi transceiver, a Bluetooth transceiver, an NFC transceiver, a cellular transceiver, etc.) for communicating with client devices. BMS interface 132 may be configured to receive building management inputs from middleware 14 or directly from one or more BMS subsystems 20-26. BMS interface 132 and/or middleware 14 can include any number of software buffers, queues, listeners, filters, translators, or other communications-supporting services.

Still referring to FIG. 3, BMS controller 12 is shown to include a processing circuit 134 including a processor 136 and memory 138. Processor 136 may be a general purpose or specific purpose processor, an application specific integrated circuit (ASIC), one or more field programmable gate arrays (FPGAs), a group of processing components, or other suitable processing components. Processor 136 is configured to execute computer code or instructions stored in memory 138 or received from other computer readable media (e.g., CDROM, network storage, a remote server, etc.).

Memory 138 may include one or more devices (e.g., memory units, memory devices, storage devices, etc.) for storing data and/or computer code for completing and/or facilitating the various processes described in the present disclosure. Memory 138 may include random access memory (RAM), read-only memory (ROM), hard drive storage, temporary storage, non-volatile memory, flash memory, optical memory, or any other suitable memory for storing software objects and/or computer instructions. Memory 138 may include database components, object code components, script components, or any other type of information structure for supporting the various activities and information structures described in the present disclosure. Memory 138 may be communicably connected to processor 136 via processing circuit 134 and may include computer code for executing (e.g., by processor 136) one or more processes described herein. When processor 136 executes instructions stored in memory 138 for completing the various activities described herein, processor 136 generally configures BMS controller 12 (and more particularly processing circuit 134) to complete such activities.

Still referring to FIG. 3, memory 138 is shown to include building objects 142. In some embodiments, BMS controller 12 uses building objects 142 to group otherwise ungrouped or unassociated devices so that the group may be addressed or handled by applications together and in a consistent manner (e.g., a single user interface for controlling all of the BMS devices that affect a particular building zone or room). Building objects can apply to spaces of any granularity. For example, a building object can represent an entire building, a floor of a building, or individual rooms on each floor. In some embodiments, BMS controller 12 creates and/or stores a building object in memory 138 for each zone or room of building 10. Building objects 142 can be accessed by UI clients 16 and remote applications 18 to provide a comprehensive user interface for controlling and/or viewing information for a particular building zone. Building objects 142 may be created by building object creation module 152 and associated with equipment objects by object relationship module 158, described in greater detail below.

Still referring to FIG. 3, memory 138 is shown to include equipment definitions 140. Equipment definitions 140 stores the equipment definitions for various types of building equipment. Each equipment definition may apply to building equipment of a different type. For example, equipment definitions 140 may include different equipment definitions for variable air volume modular assemblies (VMAs), fan coil units, air handling units (AHUs), lighting fixtures, water pumps, and/or other types of building equipment.

Equipment definitions 140 define the types of data points that are generally associated with various types of building equipment. For example, an equipment definition for VMA may specify data point types such as room temperature, damper position, supply air flow, and/or other types of data measured or used by the VMA. Equipment definitions 140 allow for the abstraction (e.g., generalization, normalization, broadening, etc.) of equipment data from a specific BMS device so that the equipment data can be applied to a room or space.

Each of equipment definitions 140 may include one or more point definitions. Each point definition may define a data point of a particular type and may include search criteria for automatically discovering and/or identifying data points that satisfy the point definition. An equipment definition can be applied to multiple pieces of building equipment of the same general type (e.g., multiple different VMA controllers). When an equipment definition is applied to a BMS device, the search criteria specified by the point definitions can be used to automatically identify data points provided by the BMS device that satisfy each point definition.

In some embodiments, equipment definitions 140 define data point types as generalized types of data without regard to the model, manufacturer, vendor, or other differences between building equipment of the same general type. The generalized data points defined by equipment definitions 140 allows each equipment definition to be referenced by or applied to multiple different variants of the same type of building equipment.

In some embodiments, equipment definitions 140 facilitate the presentation of data points in a consistent and user-friendly manner. For example, each equipment definition may define one or more data points that are displayed via a user interface. The displayed data points may be a subset of the data points defined by the equipment definition.

In some embodiments, equipment definitions 140 specify a system type (e.g., HVAC, lighting, security, fire, etc.), a system sub-type (e.g., terminal units, air handlers, central plants), and/or data category (e.g., critical, diagnostic, operational) associated with the building equipment defined by each equipment definition. Specifying such attributes of building equipment at the equipment definition level allows the attributes to be applied to the building equipment along with the equipment definition when the building equipment is initially defined. Building equipment can be filtered by various attributes provided in the equipment definition to facilitate the reporting and management of equipment data from multiple building systems.

Equipment definitions 140 can be automatically created by abstracting the data points provided by archetypal controllers (e.g., typical or representative controllers) for various types of building equipment. In some embodiments, equipment definitions 140 are created by equipment definition module 154, described in greater detail below.

Still referring to FIG. 3, memory 138 is shown to include equipment objects 144. Equipment objects 144 may be software objects that define a mapping between a data point type (e.g., supply air temperature, room temperature, damper position) and an actual data point (e.g., a measured or calculated value for the corresponding data point type) for various pieces of building equipment. Equipment objects 144 may facilitate the presentation of equipment-specific data points in an intuitive and user-friendly manner by associating each data point with an attribute identifying the corresponding data point type. The mapping provided by equipment objects 144 may be used to associate a particular data value measured or calculated by BMS 11 with an attribute that can be displayed via a user interface.

Equipment objects 144 can be created (e.g., by equipment object creation module 156) by referencing equipment definitions 140. For example, an equipment object can be created by applying an equipment definition to the data points provided by a BMS device. The search criteria included in an equipment definition can be used to identify data points of the building equipment that satisfy the point definitions. A data point that satisfies a point definition can be mapped to an attribute of the equipment object corresponding to the point definition.

Each equipment object may include one or more attributes defined by the point definitions of the equipment definition used to create the equipment object. For example, an equipment definition which defines the attributes “Occupied Command,” “Room Temperature,” and “Damper Position” may result in an equipment object being created with the same attributes. The search criteria provided by the equipment definition are used to identify and map data points associated with a particular BMS device to the attributes of the equipment object. The creation of equipment objects is described in greater detail below with reference to equipment object creation module 156.

Equipment objects 144 may be related with each other and/or with building objects 142. Causal relationships can be established between equipment objects to link equipment objects to each other. For example, a causal relationship can be established between a VMA and an AHU which provides airflow to the VMA. Causal relationships can also be established between equipment objects 144 and building objects 142. For example, equipment objects 144 can be associated with building objects 142 representing particular rooms or zones to indicate that the equipment object serves that room or zone. Relationships between objects are described in greater detail below with reference to object relationship module 158.

Still referring to FIG. 3, memory 138 is shown to include client services 146 and application services 148. Client services 146 may be configured to facilitate interaction and/or communication between BMS controller 12 and various internal or external clients or applications. For example, client services 146 may include web services or application programming interfaces available for communication by UI clients 16 and remote applications 18 (e.g., applications running on a mobile device, energy monitoring applications, applications allowing a user to monitor the performance of the BMS, automated fault detection and diagnostics systems, etc.). Application services 148 may facilitate direct or indirect communications between remote applications 18, local applications 150, and BMS controller 12. For example, application services 148 may allow BMS controller 12 to communicate (e.g., over a communications network) with remote applications 18 running on mobile devices and/or with other BMS controllers.

In some embodiments, application services 148 facilitate an applications gateway for conducting electronic data communications with UI clients 16 and/or remote applications 18. For example, application services 148 may be configured to receive communications from mobile devices and/or BMS devices. Client services 146 may provide client devices with a graphical user interface that consumes data points and/or display data defined by equipment definitions 140 and mapped by equipment objects 144.

Still referring to FIG. 3, memory 138 is shown to include a building object creation module 152. Building object creation module 152 may be configured to create the building objects stored in building objects 142. Building object creation module 152 may create a software building object for various spaces within building 10. Building object creation module 152 can create a building object for a space of any size or granularity. For example, building object creation module 152 can create a building object representing an entire building, a floor of a building, or individual rooms on each floor. In some embodiments, building object creation module 152 creates and/or stores a building object in memory 138 for each zone or room of building 10.

The building objects created by building object creation module 152 can be accessed by UI clients 16 and remote applications 18 to provide a comprehensive user interface for controlling and/or viewing information for a particular building zone. Building objects 142 can group otherwise ungrouped or unassociated devices so that the group may be addressed or handled by applications together and in a consistent manner (e.g., a single user interface for controlling all of the BMS devices that affect a particular building zone or room). In some embodiments, building object creation module 152 uses the systems and methods described in U.S. patent application Ser. No. 12/887,390, filed Sep. 21, 2010, for creating software defined building objects.

In some embodiments, building object creation module 152 provides a user interface for guiding a user through a process of creating building objects. For example, building object creation module 152 may provide a user interface to client devices (e.g., via client services 146) that allows a new space to be defined. In some embodiments, building object creation module 152 defines spaces hierarchically. For example, the user interface for creating building objects may prompt a user to create a space for a building, for floors within the building, and/or for rooms or zones within each floor.

In some embodiments, building object creation module 152 creates building objects automatically or semi-automatically. For example, building object creation module 152 may automatically define and create building objects using data imported from another data source (e.g., user view folders, a table, a spreadsheet, etc.). In some embodiments, building object creation module 152 references an existing hierarchy for BMS 11 to define the spaces within building 10. For example, BMS 11 may provide a listing of controllers for building 10 (e.g., as part of a network of data points) that have the physical location (e.g., room name) of the controller in the name of the controller itself. Building object creation module 152 may extract room names from the names of BMS controllers defined in the network of data points and create building objects for each extracted room. Building objects may be stored in building objects 142.

Still referring to FIG. 3, memory 138 is shown to include an equipment definition module 154. Equipment definition module 154 may be configured to create equipment definitions for various types of building equipment and to store the equipment definitions in equipment definitions 140. In some embodiments, equipment definition module 154 creates equipment definitions by abstracting the data points provided by archetypal controllers (e.g., typical or representative controllers) for various types of building equipment. For example, equipment definition module 154 may receive a user selection of an archetypal controller via a user interface. The archetypal controller may be specified as a user input or selected automatically by equipment definition module 154. In some embodiments, equipment definition module 154 selects an archetypal controller for building equipment associated with a terminal unit such as a VMA.

Equipment definition module 154 may identify one or more data points associated with the archetypal controller. Identifying one or more data points associated with the archetypal controller may include accessing a network of data points provided by BMS 11. The network of data points may be a hierarchical representation of data points that are measured, calculated, or otherwise obtained by various BMS devices. BMS devices may be represented in the network of data points as nodes of the hierarchical representation with associated data points depending from each BMS device. Equipment definition module 154 may find the node corresponding to the archetypal controller in the network of data points and identify one or more data points which depend from the archetypal controller node.

Equipment definition module 154 may generate a point definition for each identified data point of the archetypal controller. Each point definition may include an abstraction of the corresponding data point that is applicable to multiple different controllers for the same type of building equipment. For example, an archetypal controller for a particular VMA (i.e., “VMA-20”) may be associated an equipment-specific data point such as “VMA-20.DPR-POS” (i.e., the damper position of VMA-20) and/or “VMA-20.SUP-FLOW” (i.e., the supply air flow rate through VMA-20). Equipment definition module 154 abstract the equipment-specific data points to generate abstracted data point types that are generally applicable to other equipment of the same type. For example, equipment definition module 154 may abstract the equipment-specific data point “VMA-20.DPR-POS” to generate the abstracted data point type “DPR-POS” and may abstract the equipment-specific data point “VMA-20.SUP-FLOW” to generate the abstracted data point type “SUP-FLOW.” Advantageously, the abstracted data point types generated by equipment definition module 154 can be applied to multiple different variants of the same type of building equipment (e.g., VMAs from different manufacturers, VMAs having different models or output data formats, etc.).

In some embodiments, equipment definition module 154 generates a user-friendly label for each point definition. The user-friendly label may be a plain text description of the variable defined by the point definition. For example, equipment definition module 154 may generate the label “Supply Air Flow” for the point definition corresponding to the abstracted data point type “SUP-FLOW” to indicate that the data point represents a supply air flow rate through the VMA. The labels generated by equipment definition module 154 may be displayed in conjunction with data values from BMS devices as part of a user-friendly interface.

In some embodiments, equipment definition module 154 generates search criteria for each point definition. The search criteria may include one or more parameters for identifying another data point (e.g., a data point associated with another controller of BMS 11 for the same type of building equipment) that represents the same variable as the point definition. Search criteria may include, for example, an instance number of the data point, a network address of the data point, and/or a network point type of the data point.

In some embodiments, search criteria include a text string abstracted from a data point associated with the archetypal controller. For example, equipment definition module 154 may generate the abstracted text string “SUP-FLOW” from the equipment-specific data point “VMA-20.SUP-FLOW.” Advantageously, the abstracted text string matches other equipment-specific data points corresponding to the supply air flow rates of other BMS devices (e.g., “VMA-18.SUP-FLOW,” “SUP-FLOW.VMA-01,” etc.). Equipment definition module 154 may store a name, label, and/or search criteria for each point definition in memory 138.

Equipment definition module 154 may use the generated point definitions to create an equipment definition for a particular type of building equipment (e.g., the same type of building equipment associated with the archetypal controller). The equipment definition may include one or more of the generated point definitions. Each point definition defines a potential attribute of BMS devices of the particular type and provides search criteria for identifying the attribute among other data points provided by such BMS devices.

In some embodiments, the equipment definition created by equipment definition module 154 includes an indication of display data for BMS devices that reference the equipment definition. Display data may define one or more data points of the BMS device that will be displayed via a user interface. In some embodiments, display data are user defined. For example, equipment definition module 154 may prompt a user to select one or more of the point definitions included in the equipment definition to be represented in the display data. Display data may include the user-friendly label (e.g., “Damper Position”) and/or short name (e.g., “DPR-POS”) associated with the selected point definitions.

In some embodiments, equipment definition module 154 provides a visualization of the equipment definition via a graphical user interface. The visualization of the equipment definition may include a point definition portion which displays the generated point definitions, a user input portion configured to receive a user selection of one or more of the point definitions displayed in the point definition portion, and/or a display data portion which includes an indication of an abstracted data point corresponding to each of the point definitions selected via the user input portion. The visualization of the equipment definition can be used to add, remove, or change point definitions and/or display data associated with the equipment definitions.

Equipment definition module 154 may generate an equipment definition for each different type of building equipment in BMS 11 (e.g., VMAs, chillers, AHUs, etc.). Equipment definition module 154 may store the equipment definitions in a data storage device (e.g., memory 138, equipment definitions 140, an external or remote data storage device, etc.).

Still referring to FIG. 3, memory 138 is shown to include an equipment object creation module 156. Equipment object creation module 156 may be configured to create equipment objects for various BMS devices. In some embodiments, equipment object creation module 156 creates an equipment object by applying an equipment definition to the data points provided by a BMS device. For example, equipment object creation module 156 may receive an equipment definition created by equipment definition module 154. Receiving an equipment definition may include loading or retrieving the equipment definition from a data storage device.

In some embodiments, equipment object creation module 156 determines which of a plurality of equipment definitions to retrieve based on the type of BMS device used to create the equipment object. For example, if the BMS device is a VMA, equipment object creation module 156 may retrieve the equipment definition for VMAs; whereas if the BMS device is a chiller, equipment object creation module 156 may retrieve the equipment definition for chillers. The type of BMS device to which an equipment definition applies may be stored as an attribute of the equipment definition. Equipment object creation module 156 may identify the type of BMS device being used to create the equipment object and retrieve the corresponding equipment definition from the data storage device.

In other embodiments, equipment object creation module 156 receives an equipment definition prior to selecting a BMS device. Equipment object creation module 156 may identify a BMS device of BMS 11 to which the equipment definition applies. For example, equipment object creation module 156 may identify a BMS device that is of the same type of building equipment as the archetypal BMS device used to generate the equipment definition. In various embodiments, the BMS device used to generate the equipment object may be selected automatically (e.g., by equipment object creation module 156), manually (e.g., by a user) or semi-automatically (e.g., by a user in response to an automated prompt from equipment object creation module 156).

In some embodiments, equipment object creation module 156 creates an equipment discovery table based on the equipment definition. For example, equipment object creation module 156 may create an equipment discovery table having attributes (e.g., columns) corresponding to the variables defined by the equipment definition (e.g., a damper position attribute, a supply air flow rate attribute, etc.). Each column of the equipment discovery table may correspond to a point definition of the equipment definition. The equipment discovery table may have columns that are categorically defined (e.g., representing defined variables) but not yet mapped to any particular data points.

Equipment object creation module 156 may use the equipment definition to automatically identify one or more data points of the selected BMS device to map to the columns of the equipment discovery table. Equipment object creation module 156 may search for data points of the BMS device that satisfy one or more of the point definitions included in the equipment definition. In some embodiments, equipment object creation module 156 extracts a search criterion from each point definition of the equipment definition. Equipment object creation module 156 may access a data point network of the building automation system to identify one or more data points associated with the selected BMS device. Equipment object creation module 156 may use the extracted search criterion to determine which of the identified data points satisfy one or more of the point definitions.

In some embodiments, equipment object creation module 156 automatically maps (e.g., links, associates, relates, etc.) the identified data points of selected BMS device to the equipment discovery table. A data point of the selected BMS device may be mapped to a column of the equipment discovery table in response to a determination by equipment object creation module 156 that the data point satisfies the point definition (e.g., the search criteria) used to generate the column. For example, if a data point of the selected BMS device has the name “VMA-18.SUP-FLOW” and a search criterion is the text string “SUP-FLOW,” equipment object creation module 156 may determine that the search criterion is met. Accordingly, equipment object creation module 156 may map the data point of the selected BMS device to the corresponding column of the equipment discovery table.

Advantageously, equipment object creation module 156 may create multiple equipment objects and map data points to attributes of the created equipment objects in an automated fashion (e.g., without human intervention, with minimal human intervention, etc.). The search criteria provided by the equipment definition facilitates the automatic discovery and identification of data points for a plurality of equipment object attributes. Equipment object creation module 156 may label each attribute of the created equipment objects with a device-independent label derived from the equipment definition used to create the equipment object. The equipment objects created by equipment object creation module 156 can be viewed (e.g., via a user interface) and/or interpreted by data consumers in a consistent and intuitive manner regardless of device-specific differences between BMS devices of the same general type. The equipment objects created by equipment object creation module 156 may be stored in equipment objects 144.

Still referring to FIG. 3, memory 138 is shown to include an object relationship module 158. Object relationship module 158 may be configured to establish relationships between equipment objects 144. In some embodiments, object relationship module 158 establishes causal relationships between equipment objects 144 based on the ability of one BMS device to affect another BMS device. For example, object relationship module 158 may establish a causal relationship between a terminal unit (e.g., a VMA) and an upstream unit (e.g., an AHU, a chiller, etc.) which affects an input provided to the terminal unit (e.g., air flow rate, air temperature, etc.).

Object relationship module 158 may establish relationships between equipment objects 144 and building objects 142 (e.g., spaces). For example, object relationship module 158 may associate equipment objects 144 with building objects 142 representing particular rooms or zones to indicate that the equipment object serves that room or zone. In some embodiments, object relationship module 158 provides a user interface through which a user can define relationships between equipment objects 144 and building objects 142. For example, a user can assign relationships in a “drag and drop” fashion by dragging and dropping a building object and/or an equipment object into a “serving” cell of an equipment object provided via the user interface to indicate that the BMS device represented by the equipment object serves a particular space or BMS device.

Still referring to FIG. 3, memory 138 is shown to include a building control services module 160. Building control services module 160 may be configured to automatically control BMS 11 and the various subsystems thereof. Building control services module 160 may utilize closed loop control, feedback control, PI control, model predictive control, or any other type of automated building control methodology to control the environment (e.g., a variable state or condition) within building 10.

Building control services module 160 may receive inputs from sensory devices (e.g., temperature sensors, pressure sensors, flow rate sensors, humidity sensors, electric current sensors, cameras, radio frequency sensors, microphones, etc.), user input devices (e.g., computer terminals, client devices, user devices, etc.) or other data input devices via BMS interface 132. Building control services module 160 may apply the various inputs to a building energy use model and/or a control algorithm to determine an output for one or more building control devices (e.g., dampers, air handling units, chillers, boilers, fans, pumps, etc.) in order to affect a variable state or condition within building 10 (e.g., zone temperature, humidity, air flow rate, etc.).

In some embodiments, building control services module 160 is configured to control the environment of building 10 on a zone-individualized level. For example, building control services module 160 may control the environment of two or more different building zones using different setpoints, different constraints, different control methodology, and/or different control parameters. Building control services module 160 may operate BMS 11 to maintain building conditions (e.g., temperature, humidity, air quality, etc.) within a setpoint range, to optimize energy performance (e.g., to minimize energy consumption, to minimize energy cost, etc.), and/or to satisfy any constraint or combination of constraints as may be desirable for various implementations.

In some embodiments, building control services module 160 uses the location of various BMS devices to translate an input received from a building system into an output or control signal for the building system. Building control services module 160 may receive location information for BMS devices and automatically set or recommend control parameters for the BMS devices based on the locations of the BMS devices. For example, building control services module 160 may automatically set a flow rate setpoint for a VAV box based on the size of the building zone in which the VAV box is located.

Building control services module 160 may determine which of a plurality of sensors to use in conjunction with a feedback control loop based on the locations of the sensors within building 10. For example, building control services module 160 may use a signal from a temperature sensor located in a building zone as a feedback signal for controlling the temperature of the building zone in which the temperature sensor is located.

In some embodiments, building control services module 160 automatically generates control algorithms for a controller or a building zone based on the location of the zone in the building 10. For example, building control services module 160 may be configured to predict a change in demand resulting from sunlight entering through windows based on the orientation of the building and the locations of the building zones (e.g., east-facing, west-facing, perimeter zones, interior zones, etc.).

Building control services module 160 may use zone location information and interactions between adjacent building zones (rather than considering each zone as an isolated system) to more efficiently control the temperature and/or airflow within building 10. For control loops that are conducted at a larger scale (i.e., floor level) building control services module 160 may use the location of each building zone and/or BMS device to coordinate control functionality between building zones. For example, building control services module 160 may consider heat exchange and/or air exchange between adjacent building zones as a factor in determining an output control signal for the building zones.

In some embodiments, building control services module 160 is configured to optimize the energy efficiency of building 10 using the locations of various BMS devices and the control parameters associated therewith. Building control services module 160 may be configured to achieve control setpoints using building equipment with a relatively lower energy cost (e.g., by causing airflow between connected building zones) in order to reduce the loading on building equipment with a relatively higher energy cost (e.g., chillers and roof top units). For example, building control services module 160 may be configured to move warmer air from higher elevation zones to lower elevation zones by establishing pressure gradients between connected building zones.

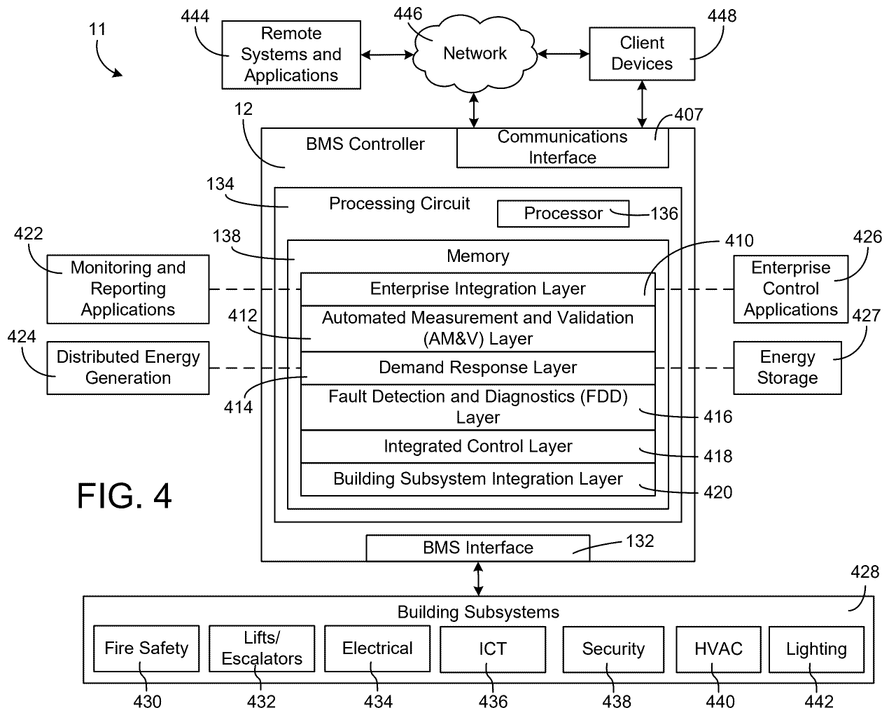

Referring now to FIG. 4, another block diagram illustrating a portion of BMS 11 in greater detail is shown, according to some embodiments. BMS 11 can be implemented in building 10 to automatically monitor and control various building functions. BMS 11 is shown to include BMS controller 12 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10.

Each of building subsystems 428 can include any number of devices, controllers, and connections for completing its individual functions and control activities. HVAC subsystem 440 can include many of the same components as HVAC system 20, as described with reference to FIGS. 2-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices and servers, or other security-related devices.

Still referring to FIG. 4, BMS controller 12 is shown to include a communications interface 407 and a BMS interface 132. Interface 407 may facilitate communications between BMS controller 12 and external applications (e.g., monitoring and reporting applications 422, enterprise control applications 426, remote systems and applications 444, applications residing on client devices 448, etc.) for allowing user control, monitoring, and adjustment to BMS controller 12 and/or subsystems 428. Interface 407 may also facilitate communications between BMS controller 12 and client devices 448. BMS interface 132 may facilitate communications between BMS controller 12 and building subsystems 428 (e.g., HVAC, lighting security, lifts, power distribution, business, etc.).

Interfaces 407, 132 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 132 can be direct (e.g., local wired or wireless communications) or via a communications network 446 (e.g., a WAN, the Internet, a cellular network, etc.). For example, interfaces 407, 132 can include an Ethernet card and port for sending and receiving data via an Ethernet-based communications link or network. In another example, interfaces 407, 132 can include a Wi-Fi transceiver for communicating via a wireless communications network. In another example, one or both of interfaces 407, 132 can include cellular or mobile phone communications transceivers. In one embodiment, communications interface 407 is a power line communications interface and BMS interface 132 is an Ethernet interface. In other embodiments, both communications interface 407 and BMS interface 132 are Ethernet interfaces or are the same Ethernet interface.

Still referring to FIG. 4, BMS controller 12 is shown to include a processing circuit 134 including a processor 136 and memory 138. Processing circuit 134 can be communicably connected to BMS interface 132 and/or communications interface 407 such that processing circuit 134 and the various components thereof can send and receive data via interfaces 407, 132. Processor 136 can be implemented as a general purpose processor, an application specific integrated circuit (ASIC), one or more field programmable gate arrays (FPGAs), a group of processing components, or other suitable electronic processing components.

Memory 138 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 138 can be or include volatile memory or non-volatile memory. Memory 138 can include database components, object code components, script components, or any other type of information structure for supporting the various activities and information structures described in the present application. According to some embodiments, memory 138 is communicably connected to processor 136 via processing circuit 134 and includes computer code for executing (e.g., by processing circuit 134 and/or processor 136) one or more processes described herein.

In some embodiments, BMS controller 12 is implemented within a single computer (e.g., one server, one housing, etc.). In various other embodiments BMS controller 12 can be distributed across multiple servers or computers (e.g., that can exist in distributed locations). Further, while FIG. 4 shows applications 422 and 426 as existing outside of BMS controller 12, in some embodiments, applications 422 and 426 can be hosted within BMS controller 12 (e.g., within memory 138).

Still referring to FIG. 4, memory 138 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 11.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 12. In yet other embodiments, enterprise control applications 426 can work with layers 410-420 to optimize building performance (e.g., efficiency, energy use, comfort, or safety) based on inputs received at interface 407 and/or BMS interface 132.

Building subsystem integration layer 420 can be configured to manage communications between BMS controller 12 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427, or from other sources. Demand response layer 414 may receive inputs from other layers of BMS controller 12 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 11 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### Fault Detection and Diagnostics Based Autonomous Control

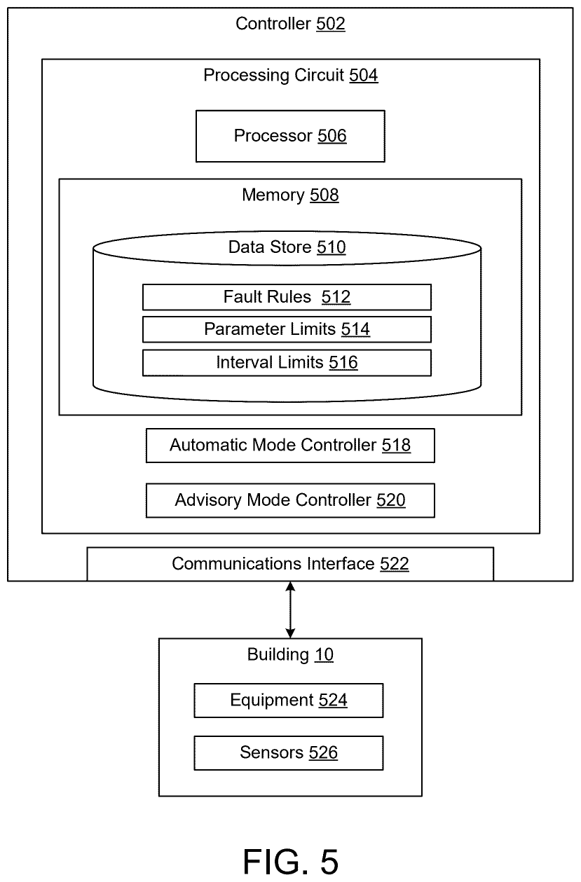

Referring to FIG. 5, a block diagram of a portion of BMS 11 in more detail, according to an exemplary embodiment. Particularly, FIG. 5 illustrates a portion of BMS 11 that operates building equipment according to fault rules 512.

The controller 502 can include a communications interface 522. For example, the communications interface 522 may include wired or wireless interfaces (e.g., jacks, antennas, transmitters, receivers, transceivers, wire terminals, etc.) for conducting data communications with various systems, devices, or networks. The communications interface 522 can include an Ethernet card and port for sending and receiving data via an Ethernet-based communications network. In another example, the communications interface 522 includes a Wi-Fi transceiver for communicating via a wireless communications network. The communications interface 522 may be configured to communicate via local area networks or wide area networks (e.g., the Internet, a building WAN, etc.). In an exemplary embodiment, the communications interface 522 facilitates communication between the controller 502, the building 10, equipment 524, and sensors 526.

The controller 502 is shown to include a processing circuit 504 including a processor 506 and memory 508. Processor 506 may be a general purpose or specific purpose processor, an application specific integrated circuit (ASIC), one or more field programmable gate arrays (FPGAs), a group of processing components, or other suitable processing components. Processor 506 is configured to execute computer code or instructions stored in memory 508 or received from other computer readable media (e.g., CDROM, network storage, a remote server, etc.).

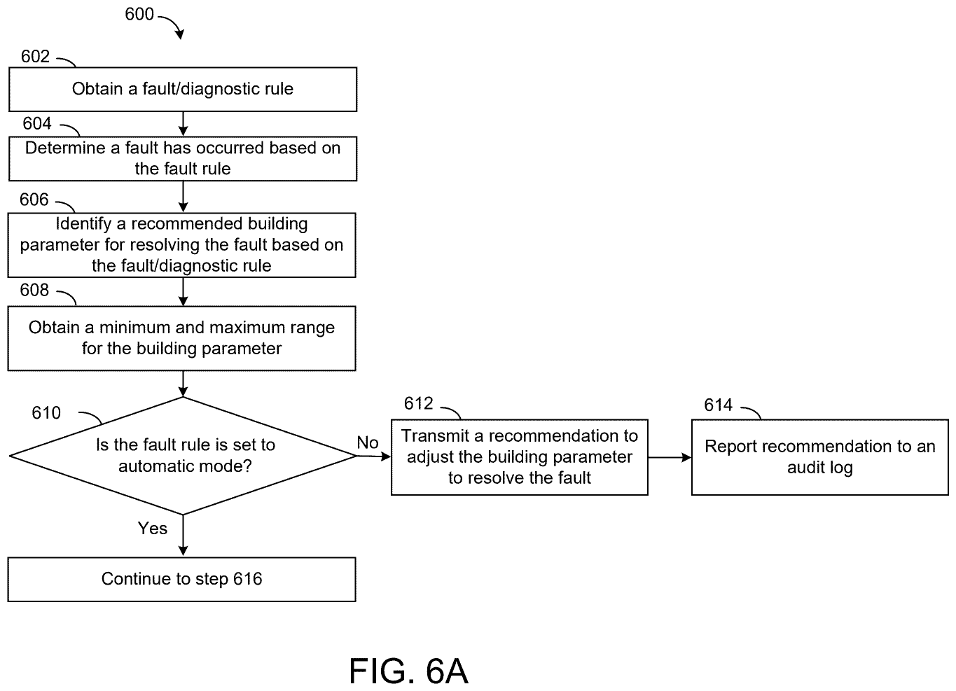

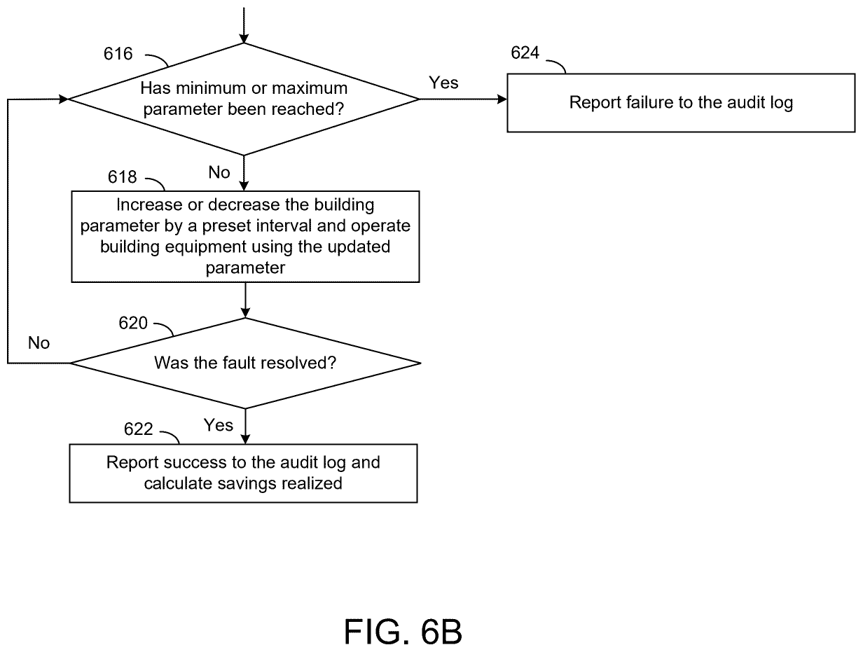

The processor 506 can utilize the fault rules 512, parameter limits 514, and interval limits 416 stored on the data store 510 of the memory 508 to operate building equipment 524. Responsive to a user input ordering a fault rule 512 be operated in automatic mode, the processor 506 can operate the automatic mode controller 518 to automatically implement adjustments to the operational parameters of the building equipment 524. In some embodiments, the controller 502 may receive operational values as setpoint inputs. In other embodiments, the controller 502 operates building equipment 524 according to a feedback loop to implement the adjustments. Responsive to a user input ordering a fault rule 512 be operated in advisory mode, the processor 506 can operate the advisory mode controller 520 to output recommended adjustments to the operational parameters of the building equipment 524. The various functions performed by the controller 502 and the components thereof are described in greater detail with reference to FIGS. 6-13.

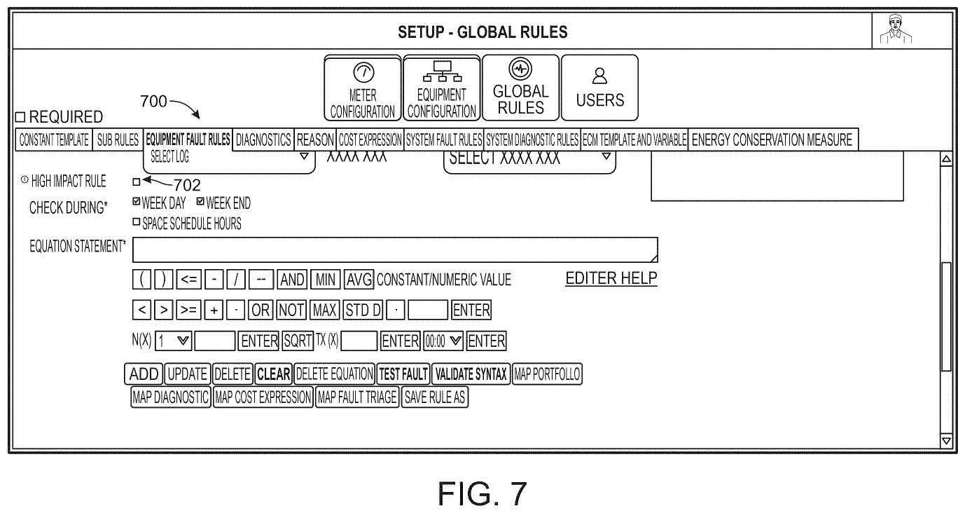

Referring to FIGS. 6A and 6B, a flowchart of a process 600 for resolving, or recommending adjustments to, resolve faults, according to an exemplary embodiment. In some embodiments, the process 600 is performed by the controller 502 and may use any of the interfaces shown in FIGS. 7-13. At step 602 the controller 502 obtains a fault/diagnostic rule. The controller 502 “obtaining” a rule includes receiving a rule as an input (e.g., a user input, an input from the cloud system 505, etc.) and/or generating a rule using a machine learning model, statistical model, generative AI, an algorithm, or anything of the like. By way of example, a user may input a rule related to a building parameter (e.g., temperature setpoint, flow rate, pressure, humidity, etc.), multiple building parameters, or any other point in the controller 502. The rule may be a fault rule or a diagnostic rule. The rule may be programmed by the user using conditional logic (e.g., if/then/else). The rules may be entered by the user in a rules editor, such as the rules editor represented in FIG. 7. In the rules editor, the user can set a rule to execute in advisory mode or automatic mode. In advisory mode, the controller 502 may send recommendations to a user device regarding adjustments to resolve a fault detected based on a user-set rule. In automatic mode, the controller 502 may operate building equipment to resolve a fault detected based on the user-set rule. The user may set rules to automatic mode or advisory mode on a rule-by-rule basis, as they are added, or may apply one mode to all rules. In some embodiments, a rule may define a BMS point that is monitored to determine whether a fault has occurred (e.g., room temperature within range) as well as one or more other BMS points that can be adjusted to affect the monitored BMS point (e.g., supply air temperature, supply air damper position, chiller water temperature, etc.).

At step 604, the controller 502 can determine if a fault has occurred based on the rules set by the user at step 602. In some embodiments, the controller 502 determines whether a fault has occurred based on sensor data that is transmitted to the controller 502 from local data engines and/or directly from the sensors. For example, if a room's temperature deviates from its setpoint past a preset threshold, then the controller 502 may determine that the temperature deviation is a fault. In some embodiments, a fault may be detected by trend data. For example, if trending flow rates indicate that a temperature will deviate from a setpoint, the controller 502 may determine this is a fault. In other embodiments, the controller 502 determines a fault has occurred based on a combination of building parameters. For example, deviation from a temperature setpoint in combination with a change in humidity level may cause the controller 502 to detect a fault. At step 606 the controller 502 may identify a building parameter or building parameters to adjust to resolve the fault based on the fault/diagnostic rule.

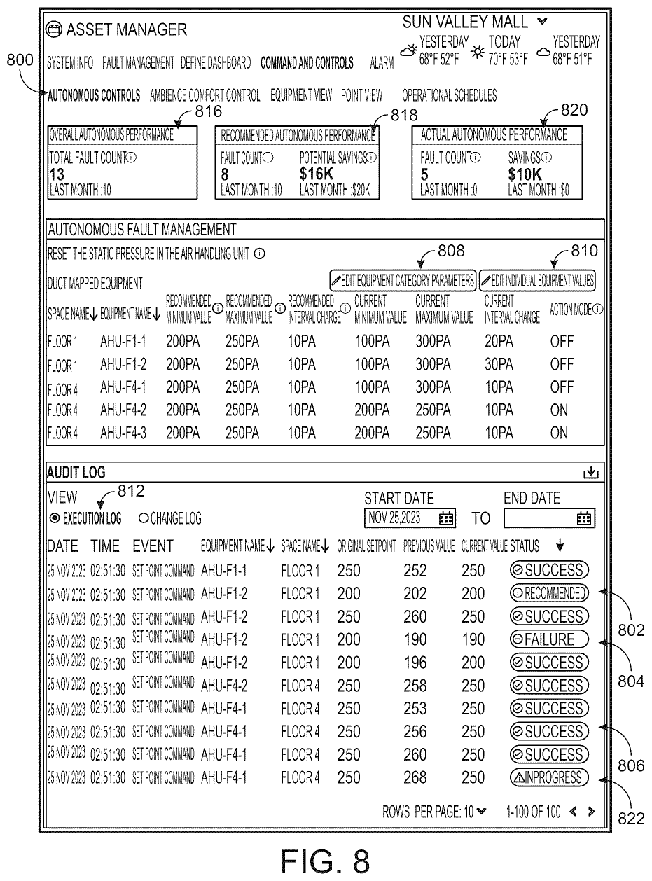

At step 608, the controller 502 obtains a building parameter range that limits changes to the building parameter made or recommended by the controller 502. The controller 502 may receive one or more building parameter thresholds as an input (e.g., a user input, an input from the cloud system 505, etc.) or the controller 502 may generate the one or more building parameters using internal logic (e.g., by applying a machine learning model, statistical model, generative AI, an algorithm, etc.). For example, a user may set a minimum threshold, a maximum threshold, and an interval of change that operates within the minimum and maximum thresholds. The minimum threshold may define a minimum permissible value for a point of the controller 502 which can be adjusted to affect the building parameter, whereas the maximum threshold may define a maximum permissible value for the point of the controller 502. The thresholds may be set as a percentage (e.g., +/−10%, +/−20%, etc.) of a default value of the controller 502 point and applied to categories of equipment or spaces. For example, a user may set a lower limit of 80% the default value of the controller 502 point and an upper limit of 120% the default value of the controller 502 point. In this way, the limits are applicable to all types of building equipment/devices regardless of the units or scale of the building parameter values. The interval of change may define an amount by which the building parameter is changed at a given time during operation of the process 600. The interval of change can also be defined as a percentage in some embodiments (e.g., +/−1%, +/−2%, etc.). Alternatively, a user may set the minimum and maximum thresholds and/or the interval in terms of operational value. For example, a user may set a minimum value of 60° F. and a maximum value of 80° F. and an interval of 2° F. The minimum thresholds, maximum thresholds, and interval of change may be input or edited by the user on various GUIs displayed on user devices communicatively coupled with the controller 502 (e.g., the asset manager GUI of FIGS. 8-13). In this way, the system operates to mitigate and resolve faults without operating in an extreme state. Advantageously, this increases short term savings for the user and reduces the potential of causing equipment damage or failure when addressing a fault.

In an example, the controller 502 adjusts the position of supply air dampers to regulate airflow to a room, thereby controlling the room's temperature. The minimum threshold may be defined as 80% of the default damper setpoint, whereas the maximum threshold may be 120% of the default damper setpoint. If the room temperature falls below a desired level (i.e., a temperature setpoint), the controller increases the damper position by the predefined increment of change percentage until the temperature reaches the setpoint. If the room temperature exceeds the desired level, the controller 502 decreases the damper setpoint incrementally until the temperature stabilizes. In this example, if the default damper setpoint is 50%, the minimum damper setpoint would be 40% and the maximum damper setpoint would be 60%, and during operation the controller 502 adjusts the damper setpoint within the 40% and 60% limits to maintain room comfortable temperature. In some embodiments, the controller 502 may directly operate the dampers to open or close in order to achieve a desired temperature setpoint.

In another example, the controller 502 manages a chiller system to regulate the fluid temperature circulated for cooling a room. A user may define the thresholds and interval of change in terms of operational values, rather than percentages. For example, the user defines the minimum threshold as 42° F., the maximum threshold as 50° F., and an interval of change of 0.5° F. If the circulated fluid temperature falls below the 42° F., the chiller output is increased gradually. If the water temperature exceeds 50° F., the chiller output is decreased gradually. In some embodiments, the minimum threshold and maximum threshold may be recommended based on the weather. For example, if the outdoor temperature is 45° F., and the chiller setpoint falls below 45° F., a fault is detected and the controller 502 increases the setpoint gradually (e.g., by 0.5° F.).

At step 610, the controller 502 determines if the corresponding fault rule is set to “automatic mode” (also referred to herein as “action mode”) or advisory mode. In advisory mode, the controller 502 can transmit a recommendation diagnosing the fault to a user device (step 612). The transmitted recommendation may include suggested adjustments for the user to make in order to resolve or mitigate the fault. At step 614, the recommendation is reported to and displayed on an audit log that may be accessed by users (e.g., the “recommended” entry 802 shown in FIG. 8).

In automatic mode (i.e., action mode), the controller 502 proceeds to make adjustments automatically to resolve or mitigate the fault (steps 616-620). At step 616, the controller 502 determines whether the preset minimum or maximum threshold has been reached, according to exemplary embodiments. If the controller 502 determines that the preset minimum or maximum threshold has been reached, the controller 502 may report and display a failure on the audit log (e.g., the failure entry 804 shown in FIG. 8).

At step 618, responsive to the controller 502 determining that the parameter is within the minimum and maximum threshold range, the controller 502 can increase or decrease the building parameter by a preset interval to generate an updated parameter. The controller 502 may utilize the updated building parameter to operate building equipment/devices. For example, if the controller 502 determines that an HVAC system's airflow is causing fluctuations in static air pressure, the controller 502 may increase airflow rates, and fan speeds by the preset interval (e.g., 5%).

At step 620, the controller 502 determines whether or not the fault was resolved after operating the building equipment according to the updated parameter, according to exemplary embodiments. At step 622, if the fault was resolved, the success can be reported to and displayed on the audit log (e.g., the “success” entry 806 shown in FIG. 8). Additionally, or alternatively, the controller 502 may calculate the monetary savings realized by successfully resolving the fault. The savings realized may be accessed by a user on a user interface (e.g., the asset manager GUI shown in FIGS. 8-13). If the fault was not resolved, the controller 502 repeats the process starting from step 616, according to exemplary embodiments. The controller 502 continues repeating the process of updating the building parameter and checking if the fault was resolved until the fault is successfully resolved or the minimum/maximum value threshold has been reached. At step 624, if the fault is not resolved in automatic mode because the minimum or maximum threshold has been reached, the controller 502 may report and display a failure to the audit log.

Referring to FIG. 7, a rule editor 700 that can be used to define a custom fault rule and/or diagnostic rule is shown, according to an exemplary embodiment. A custom rule is any rule which has been defined by the user and is not part of a global rule library. The rule editor can be used to define equipment fault rules and equipment diagnostic rules, as well as system-wide fault rules and diagnostic rules. The rules editor may be used to define both fault rules and diagnostic rules that can later be mapped to newly created fault rules or existing rules within the available library. In exemplary embodiments, the rule editor 700 is used to set the fault/diagnostic rule of step 602 shown in FIG. 6A.

The rule editor 700 can be accessed by a user by selecting the “equipment fault rules” tab on an interactive dashboard GUI accessible by a user device (e.g., the asset manager of FIGS. 8-13. The user may define their own diagnostic rules from a list of process points. The user defined diagnostic rules may replace default diagnostic rules that are preprogrammed into the system or may supplement the default diagnostic rules. The user may select “high impact rule” when defining a rule in the rule editor 700. By selecting “high impact rule,” the user enables the controller 502 to enter “automatic mode” and autonomously apply the diagnostic rule to take mitigative or corrective actions to address a detected fault, according to an exemplary embodiment. If a user does not select “high impact rule” the controller 502 remains in advisory mode, according to some embodiments. When in advisory mode, the controller 502 can transmit a notification to a user device that includes recommended actions for a user to take to mitigate or resolve a fault.

Referring to FIG. 8, an asset manager GUI that can be accessed by a user on a user device is shown, according to an exemplary embodiment. Within the asset manager interface, the user may access a variety of asset management tabs, including an autonomous controls tab 800.

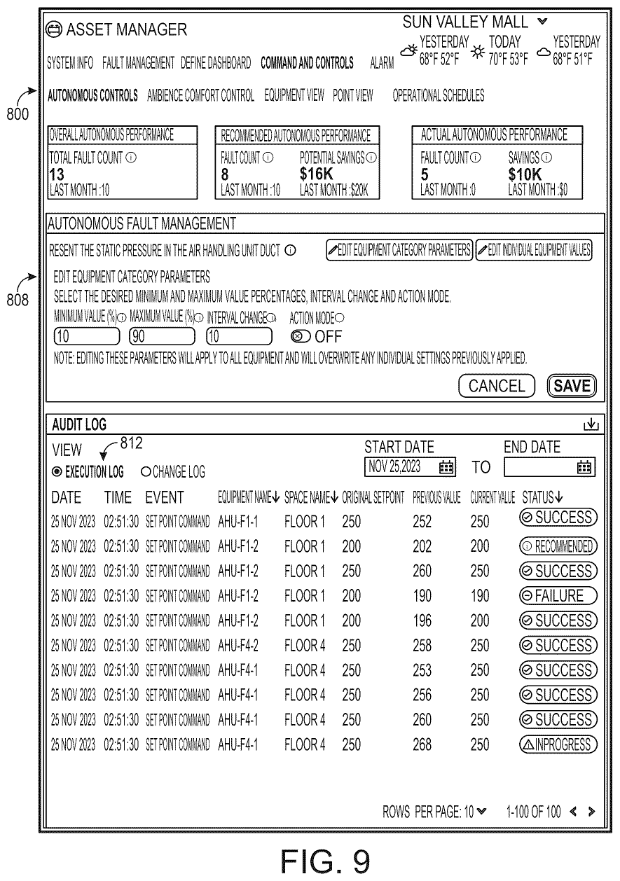

On the autonomous controls tab 800 the user can view various performance widgets. The autonomous performance widgets are shown to include fault counts and estimated system savings over a predetermined period (e.g., a month, a quarter, a year, all time, etc.). A user may access editors, including the equipment category parameters editor 808 and an equipment values editor 810. The editors 808 and 810 are explored in greater detail with regards to FIG. 9.

The performance widgets can include an “overall autonomous performance” widget 816, a “recommended autonomous performance” widget 818, and an “actual autonomous performance” widget 820. The “overall autonomous performance” widget 816 is shown to include the total fault count over a predetermined period (e.g., a month, a quarter, a year, all time, etc.). The total fault count is a summation of the faults that occur in advisory mode (e.g., the total faults shown in the “recommended autonomous performance” widget) and the faults that occur in automatic mode (e.g., the total faults shown in the “actual autonomous performance” widget). By way of example, the total fault count may include each instance that the controller 502 determines a fault has occurred based on a fault rule (e.g., step 604 of FIG. 6A). Alternatively, the total fault count may be determined based on the types of faults that have occurred over the predetermined period. For example, the total fault count may represent the number of fault rules that were violated in the predetermined period, rather than representing each instance the fault rules were violated. In some embodiments, the user may click on the “overall autonomous performance” widget 902 to view more details about the faults included on the total fault count.

The “recommended autonomous performance” widget 904 is shown to include a fault count over a predetermined period (e.g., a week, a month, a quarter, etc.). The fault count displayed on the “recommended autonomous performance” widget 904 is shown to include faults that have occurred while the system, or pieces of equipment, are in advisory mode. For example, the fault count displayed on the “recommended autonomous performance” widget 904 can be a count of each instance that the controller 502 determined a fault has occurred within the system based on a fault rule (e.g., step 604 of FIG. 6A) and transmitted a recommendation to resolve the fault (e.g., step 612 of FIG. 6A). Alternatively, the fault count displayed on the “recommended autonomous performance” widget 904 may represent the number of fault rules set to advisory mode (e.g., non-high impact rules) that were violated in the predetermined period, rather than representing each instance the advisory mode fault rules were violated. The “recommended autonomous performance” widget can also include a potential savings value. The potential savings value may be estimated by calculating the difference between the actual cost of operating the system over the predetermined period and the estimated cost of operating the piece of equipment over the predetermined period had all the equipment been operated in automatic mode. In some embodiments, the user may click on the “recommended autonomous performance” widget 904 to view a log of recommended parameter adjustments over the predetermined period and the cost savings associated with each recommended parameter adjustment.

The “actual autonomous performance” widget 820 is shown to include an actual total fault count over a predetermined period (e.g., a week, a month, a quarter, etc.). The fault count displayed on the “actual autonomous performance” widget 820 is shown to include faults that have occurred while the system, or pieces of equipment, are in autonomous mode. For example, the fault count displayed on the “actual autonomous performance” widget 906 can be a count of each instance that the controller 502 determined a fault has occurred based on a rule (e.g., step 604 of FIG. 6A). Alternatively, the fault count displayed on the “actual autonomous performance” widget 820 may represent the number of faults set to autonomous mode (e.g., high impact rules) that were violated in the predetermined period, rather than representing each instance the autonomous mode fault rules were violated. The widget can also include an estimated savings value, which may be projected by calculating the difference between the actual cost of operating the piece of equipment over the predetermined period in autonomous mode and the estimated cost of operating the piece of equipment over the predetermined period without autonomous mode. In some embodiments, the user may click on the “actual autonomous performance” widget 820 to view a log of actual parameter adjustments over the predetermined period and the cost savings associated with each actual parameter adjustment.

The asset manager GUI can further include an audit log. In the view shown in FIG. 8, the execution log view of the audit log is selected and visible to the user. In the execution log, the user can view an overview of adjustments to building parameters over a preset time range (e.g., one day, one week, one month, etc.). The user may adjust the time range of values displayed by entering a start date and end date on the audit log. In advisory mode, the controller 502 can transmit a recommended building parameter adjustment to the user device and the audit log can be updated to note a “recommended” entry 802.

Building parameters may be automatically adjusted by the controller 502 when in autonomous mode. When adjusting the building parameters, the controller 502 increases or decreases the building parameter by preset intervals, according to some embodiments. For example, increasing flow rate by 2% until a fault is resolved. Responsive to an increase or decrease of the building parameter resulting in an updated building parameter, the audit log is updated to note a “success” entry 806. Responsive to an increase or decrease of a building parameter not being applied by the controller 502 (e.g., if the BMS system is offline, undergoing maintenance, etc.), the audit log is updated to note a “failure” entry 804. In some embodiments, the controller 502 can evaluate whether a fault was resolved after making updating the building parameter. In some embodiments, the audit log is updated to note a “success” entry when the updated building parameter resolves the detected fault. In this example, if adjusting a building parameter would exceed a predetermined minimum or maximum threshold, the audit log may be updated to note a “failure” entry. While the controller 502 is in the process of automatically adjusting the building parameters for a system or a particular piece of equipment, the audit log is updated to note an “In Progress” entry 822.

Referring to FIG. 9, the asset manager GUI of FIG. 8 is shown, according to exemplary embodiments. While on the autonomous controls tab 800, a user may edit category parameters (i.e., building parameters) under an autonomous fault configuration widget. Upon selecting the edit category parameters icon 808 (shown in FIG. 8), a user may enter a minimum threshold value, a maximum threshold value, and an interval change value. Categories may be edited in terms of percentages. In this way, the minimum value percentage, maximum value percentage, and interval change value percentage may be applied to all building parameters across categories (e.g., temperatures, flow rates, static pressure, etc.). The settings chosen in the category parameters editor 808 may override individual equipment parameters or default parameters that were set previously. If the user selects “action mode” on the category parameters editor 808 the controller 502 may enter automatic mode. In this way, the controller 502 may automatically adjust building parameters by the interval of change when the controller 502 detects a fault.

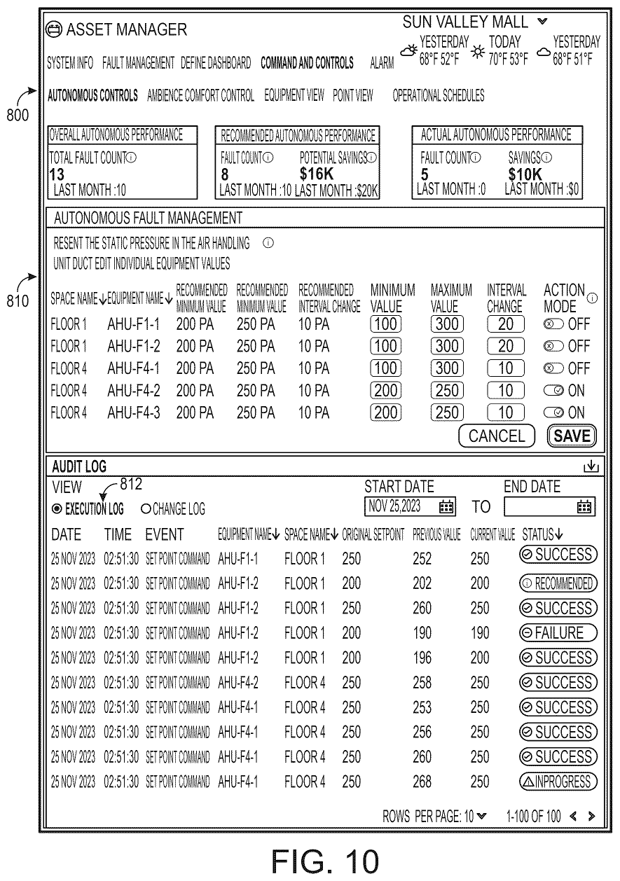

Referring to FIG. 10, the asset manager GUI of FIG. 8 is shown, according to exemplary embodiments. While on the autonomous controls tab 800, a user may edit parameters for individual pieces of building equipment under an autonomous fault management widget. On the equipment values threshold (i.e., parameters) editor 810, a user can enter a minimum threshold value, a maximum threshold value, and an interval change value. The values can include building equipment parameters such as temperature, flow rate, or anything of the like. In this way, the minimum threshold, maximum threshold, and interval change value percentage may be tailored to specific equipment. For example, the user may set the threshold value ranges between 75° F.-90° F. for equipment corresponding to a particular room on a particular floor if they desire for that room to remain warmer relative to other rooms on the same floor. As an example, an air handling unit in a building's library may be set to a minimum threshold value of 65° F. and a maximum value of 70° F., with an interval of change of 1° F. In this way, the library is kept within the ideal temperature range for preserving books and documents and is set to avoid sudden changes in temperature. If the user toggles an “action mode” option on the equipment values editor 810 the controller 502 can enter automatic mode. The user may toggle “action mode” (i.e., automatic mode) to “on” for some or all building equipment. In automatic mode, the controller 502 can autonomously operate the equipment within the preset thresholds. The user may also choose to leave “action mode” toggled off, which keeps the controller 502 in “advisory mode,” according to exemplary embodiments.

In some embodiments, the controller 502 generates recommended parameters that can be displayed on the equipment values editor 810. The recommended parameters can include recommended minimum and maximum threshold values, and recommended intervals of change. The controller 502 can generate these recommendations by employing machine learning algorithms that consider user habits over time. The machine learning algorithm may apply factors like historical use data, occupancy data, weather, environmental sustainability goals, equipment performance metrics, cost efficacy, or any combination thereof. In this way, the recommended values are unique to the customer's habits and concerns. Alternatively, the controller 502 can generate these recommended values based on broader criteria observed across larger populations, such as general cost efficacy, general comfort, or a combination thereof.

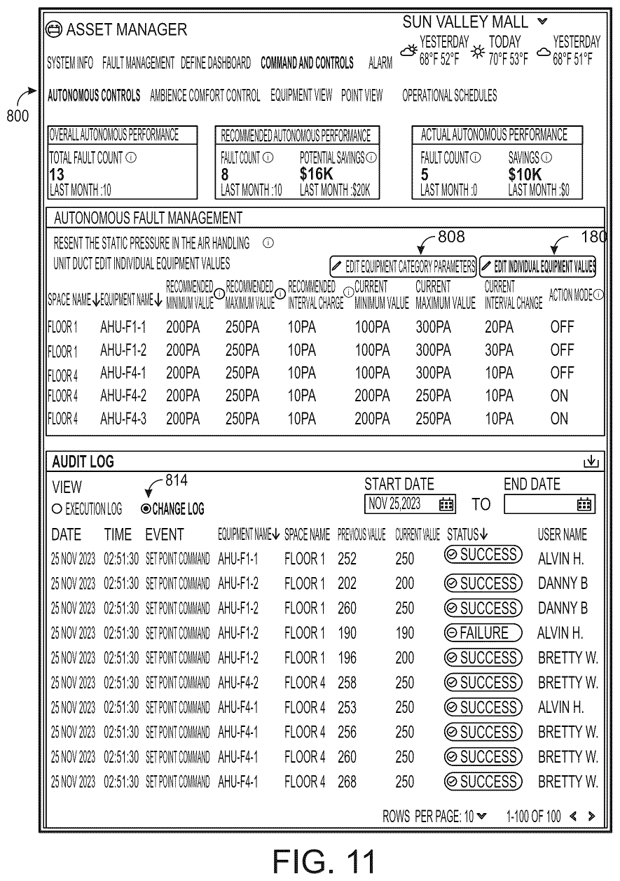

Referring to FIG. 11, the asset manager GUI of FIG. 8 is shown with the audit log on in a change log view 814, according to exemplary embodiments. In this view, user can see what threshold values have been changed, when they were changed, and what user changed the threshold values. The user may also view when the equipment rules are changed such that the equipment switches from operating in action mode (i.e., automatic mode) to operating in advisory mode. In exemplary embodiments, the change log includes previous building parameter values and current building parameter values (e.g., the building parameter after being adjusted by the controller 502).

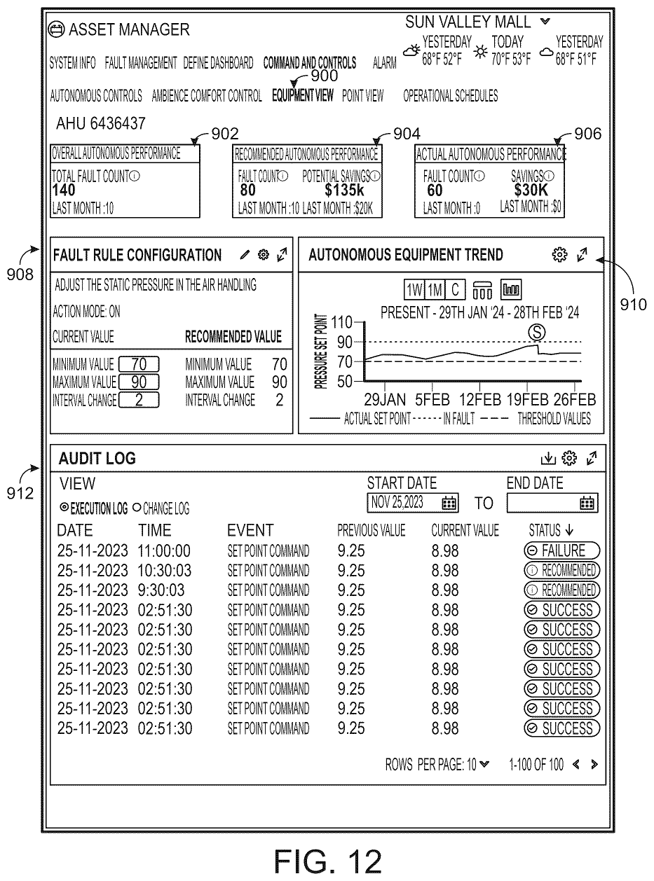

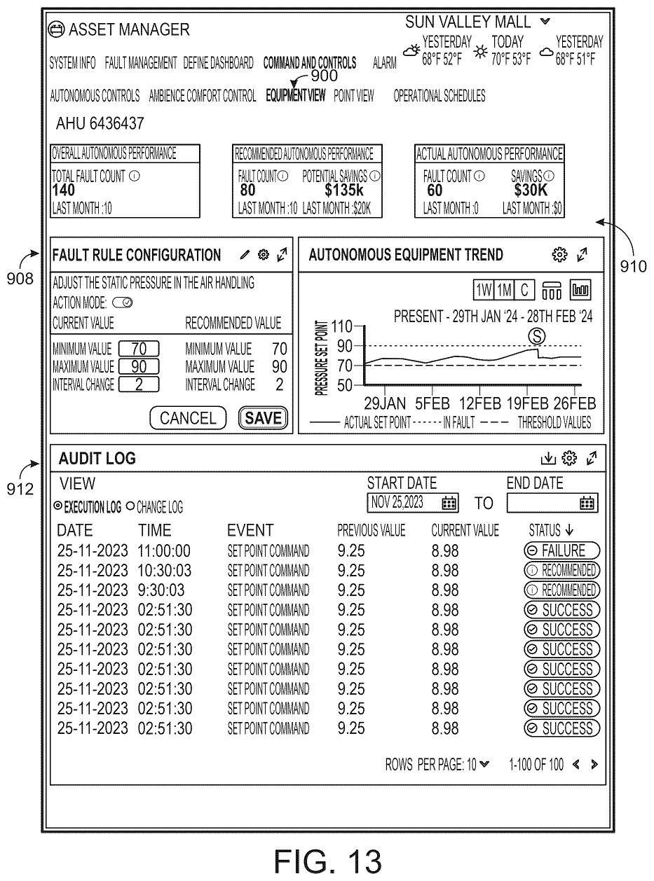

Referring to FIG. 12 and FIG. 13, an equipment view tab of the asset manager GUI of FIG. 8 is shown, according to exemplary embodiments. The equipment view tab 900 contains dashboards for individual pieces of building equipment, according to exemplary embodiments. As shown in FIG. 12, an equipment view dashboard is shown to include a set of performance widgets, a “fault rule configuration” widget 908, an “autonomous equipment trend” widget 910, and an equipment specific audit log widget 912.

The set of performance widgets can include an “overall autonomous performance” widget 902, a “recommended autonomous performance” widget 904, and an “actual autonomous performance” widget 906. The “overall autonomous performance” widget 902 is shown to include the total fault count over a predetermined period (e.g., a month, a quarter, a year, all time etc.) for an individual piece of building equipment. The total fault count is a summation of the faults that occur in advisory mode (e.g., the total faults shown in the “recommended autonomous performance” widget) and the faults that occur in automatic mode (e.g., the total faults shown in the “actual autonomous performance” widget). By way of example, the total fault count may include each instance that the controller 502 determines a fault has occurred based on a fault rule (e.g., step 604 of FIG. 6A). Alternatively, the total fault count may be determined based on the types of faults that have occurred over the predetermined period. For example, the total fault count may represent the number of fault rules that were violated in the predetermined period, rather than representing each instance the fault rules were violated. In some embodiments, the user may click on the “overall autonomous performance” widget 902 to view more details about the faults included on the total fault count.

The “recommended autonomous performance” widget 904 is shown to include a fault count for the individual piece of building equipment over a predetermined period (e.g., a week, a month, a quarter, etc.). The fault count displayed on the “recommended autonomous performance” widget 904 is shown to include faults that have occurred while the piece of equipment, is in advisory mode. For example, the fault count displayed on the “recommended autonomous performance” widget 904 can be a count of each instance that the controller 502 determined a fault has occurred based on a rule (e.g., step 604 of FIG. 6A) and transmitted a recommendation to resolve the fault (e.g., step 612 of FIG. 6A). Alternatively, the fault count displayed on the “recommended autonomous performance” widget 904 may represent the number of fault rules set to advisory mode (e.g., non-high impact rules) that were violated in the predetermined period, rather than representing each instance the advisory mode fault rules were violated. The widget can also include an estimated savings value, which may be projected by calculating the difference between the actual cost of operating the piece of equipment over the predetermined period and the estimated cost of operating the piece of equipment over the predetermined period had all the recommended values been implemented and had the equipment been operated in automatic mode. In some embodiments, the user may click on the “recommended autonomous performance” widget 904 to view a log of recommended parameter adjustments over the predetermined period and the cost savings associated with each recommended parameter adjustment.

The “actual autonomous performance” widget 906 is shown to include an actual total fault count over a predetermined period (e.g., a week, a month, a quarter, etc.) for the individual piece of building equipment. The fault count displayed on the “actual autonomous performance” widget 906 is shown to include faults that have occurred while the system, or a particular piece of equipment, is in autonomous mode. For example, the fault count displayed on the “actual autonomous performance” widget 906 can be a count of each instance that the controller 502 determined a fault has occurred based on a rule (e.g., step 604 of FIG. 6A)). Alternatively, the fault count displayed on the “recommended autonomous performance” widget 904 may represent the number of faults set to autonomous mode (e.g., high impact rules) that were violated in the predetermined period, rather than representing each instance the advisory mode fault rules were violated. The widget can also include an estimated savings value, which may be projected by calculating the difference between the actual cost of operating the piece of equipment over the predetermined period and the estimated cost of operating the piece of equipment over the predetermined period had no recommended changes been implemented and had no threshold values been set. In some embodiments, the user may click on the “recommended autonomous performance” widget 904 to view a log of actual parameter adjustments over the predetermined period and the cost savings associated with each actual parameter adjustment.

The “fault rule configuration” widget 908 is shown to include the current values and recommended values for the selected piece of equipment. These are the same values that may be accessed by the user on the autonomous controls tab under “equipment” shown in FIG. 8. As shown in FIG. 13, the fault rules may be edited by the user in this widget. For example, the user may enter an editor view after clicking the pencil icon in the top right corner. In the editor, the user may adjust a minimum threshold value, a maximum threshold value, and/or an interval change for the selected piece of equipment. The user may also toggle between automatic mode (i.e., action mode) and advisory mode in the editor view, according to some embodiments.

The “autonomous equipment trend” widget 910 can display a setpoint trendline of the equipment over time. In this way, a user can view the changes to a set point over time. The trendlines may be interactive. For example, a user may be able to hover over or click on a point on the trend line to view the cost of operating at the selected setpoint.

The equipment specific audit log widget 912, similarly to the general autonomous controls audit log shown in FIGS. 8-11, may include an execution log or a change log. As shown, the execution log shows events that occur, such as set point changes, according to exemplary embodiments. The execution log indicates whether the system succeeded or failed to achieve the setpoint command. When not set to automatic mode, the execution log indicates “recommended” when a change was recommended by not implemented by the user. In some embodiments, the execution log includes an indication of whether, upon implementing the recommended change, the fault was successfully resolved. For example, if upon implementing the recommended change the fault was successfully resolved, the “recommended” icon on the audit log may be green. If upon implementing the recommended change a fault was not successfully resolved, the “recommended” icon on the audit log may be red. In instances where a recommendation was not implemented, the “recommended” icon may be blue. Additionally, or alternatively, the audit log may display “recommended: success” or “recommended: failure” for implemented recommendations.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied, and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Also, two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

What is claimed is:

1. A building management system (BMS) comprising one or more memory devices storing instructions thereon that, when executed by one or more processors, cause the one or more processors to perform operations comprising:
obtaining a fault rule related to one or more building parameters;
determining that a fault has occurred based on the fault rule and initial BMS data indicating an initial value of the one or more building parameters;
responsive to determining that the fault has occurred, perform an automatic fault correction process comprising:
increasing or decreasing an operational value of building equipment that operate to affect the one or more building parameters by a preset interval;
operating the building equipment using the increased or decreased operational value to affect the one or more building parameters; and
determining whether the fault was resolved after operating the building equipment using the increased or decreased operational value based on new BMS data indicating a new value of the one or more building parameters; and
responsive to determining that the fault was not resolved, repeating the automatic fault correction process until either the fault is resolved or the operational value of the building equipment reaches a minimum or maximum value threshold.

2. The BMS of claim 1, the operations comprising:
providing a user interface to a user device, the user interface comprising a plurality of selectable elements;
receiving, via the user device displaying the user interface, an indication of a selection of a first selectable element of the plurality of selectable elements, the first selectable element being associated with a rule editor for a building parameter of the one or more building parameters; and
identifying, responsive to the receipt of the indication, an updated rule for the building parameter.

3. The BMS of claim 1, the operations comprising obtaining a rule for a building parameter of the one or more building parameters, the rule for the building parameter comprising the minimum or maximum value threshold for the operational value and the preset interval for increasing or decreasing the operational value.

4. The BMS of claim 1, the operations comprising providing a user interface to a user device, the user interface comprising:
a graphical representation of a rule for a building parameter of the one or more building parameters; and
an audit log containing elements representative of the building parameter and a successful update of the building parameter.

5. The BMS of claim 4, the operations comprising updating the user interface to include:
a potential savings value resulting from performing the automatic fault correction process for all detected faults; and
an actual savings value resulting from current settings that do not perform the automatic fault correction process for all faults.

6. The BMS of claim 1, wherein the fault rule for the one or more building parameters identifies:
a first BMS point that provides values of the one or more building parameters, wherein the first BMS point is monitored to determine whether the fault has occurred; and
a second BMS point that provides values of the operational value of the building equipment, wherein the second BMS point is adjusted to affect the operation of the building equipment.

7. The BMS of claim 1, wherein:
The fault rule comprises an indication as to whether the fault rule is set to advisory mode or automatic mode;
the automatic fault correction process is performed responsive to determining that the fault has occurred and the fault rule is set to automatic mode; and
a recommendation is provided responsive to determining that the fault has occurred and the fault rule is set to advisory mode.

8. The BMS of claim 1, the operations comprising, transmitting a failure message to a user device indicating that the automatic fault correction process failed to correct the fault responsive to determining that the operational value of the building equipment has reached the minimum or maximum value threshold and the fault has not been resolved.

9. The BMS of claim 1, wherein the minimum or maximum value threshold is defined as a percentage; and
the operations include applying the percentage to a default value of the operational value to determine a numerical threshold and comparing a current value of the operational value against the numerical threshold to determine whether the minimum or maximum value threshold has been reached.

10. The BMS of claim 1, wherein the preset interval is defined as a percentage; and
the operations include applying the percentage to a default value of the operational value to determine an amount by which the operational value is increased or decreased when adjusting by the preset interval.

11. A method, comprising:
obtaining a fault rule related to one or more building parameters;
determining that a fault has occurred based on the fault rule and initial BMS data indicating an initial value of the one or more building parameters;
responsive to determining that the fault has occurred, performing an automatic fault correction process comprising:
increasing or decreasing an operational value of building equipment that operate to affect the one or more building parameters by a preset interval;
operating the building equipment using the increased or decreased operational value to affect the one or more building parameters; and
determining whether the fault was resolved after operating the building equipment using the increased or decreased operational value based on new BMS data indicating a new value of the one or more building parameters; and
responsive to determining that the fault was not resolved, repeating the automatic fault correction process until either the fault is resolved or the operational value of the building equipment reaches a minimum or maximum value threshold.

12. The method of claim 11, further comprising:
providing a user interface to a user device, the user interface comprising a plurality of selectable elements;
receiving, via the user device displaying the user interface, an indication of a selection of a first selectable element of the plurality of selectable elements, the first selectable element being associated with a rule editor for a building parameter of the one or more building parameters; and
identifying, responsive to the receipt of the indication, an updated rule for the building parameter.

13. The method claim 11, further comprising receiving a rule for a building parameter of the one or more building parameters, the rule for the building parameter comprising the minimum or maximum value threshold for the operational value and the preset interval for increasing or decreasing the operational value.

14. The method of claim 11 further comprising:
providing a user interface to a user device, the user interface comprising:
a graphical representation of a rule for a building parameter of the one or more building parameters, and
an audit log containing elements representative of the building parameter and a successful update of the building parameter.

15. The method of claim 14 further comprising:
calculating a potential savings value resulting from performing the automatic fault correction process for all detected faults;
calculating an actual savings value resulting from current settings that do not perform the automatic fault correction process for all faults; and
updating the user interface to display the calculated potential savings value and the actual savings value.

16. The method of claim 11, wherein:
the fault rule comprises an indication as to whether the fault rule is set to advisory mode or automatic mode;
the automatic fault correction process is performed responsive to determining that the fault has occurred and the fault rule is set to automatic mode; and
a recommendation is provided responsive to determining that the fault has occurred and the fault rule is set to advisory mode.

17. The method of claim 11 further comprising:
transmitting a failure message to a user device indicating that the automatic fault correction process failed to correct the fault responsive to determining that the operational value of the building equipment has reached the minimum or maximum value threshold and the fault has not been resolved.

18. The method of claim 11, wherein the minimum or maximum value threshold is defined as a percentage, the method further comprising:
applying the percentage to a default value of the operational value to determine a numerical threshold, and
comparing a current value of the operational value against the numerical threshold to determine whether the minimum or maximum value threshold has been reached.

19. A user device storing instructions thereon that, when executed by one or more processors, cause the one or more processors to perform operations comprising:
receiving a rule for a building parameter;
transmitting, to a BMS, the rule for the building parameter;
receiving, from the BMS, equipment data for a plurality of pieces of building equipment, the equipment data including updates to the building parameter;
generating, using the equipment data for the plurality of pieces of building equipment and the updates to the building parameter, a plurality of recommendations to adjust operational parameters for the plurality of pieces of building equipment; and
providing, responsive to generating the plurality of recommendations, a user interface to the user device, the user interface including:
a graphical representation indicating the plurality of recommendations; and
an element to indicate the updates to the building parameter.

20. The user device of claim 19, the operations comprising:
receiving, from the BMS, a savings value resulting from implementing one or more of the plurality of recommendations; and
updating the user interface to display the savings value.
